(19) United States
(12) Patent Application Publication
(10) Pub. No.: US 2014/0334689 A1
(43) Pub. Date: Nov. 13, 2014

(54) INFRASTRUCTURE ASSESSMENT VIA IMAGING SOURCES

(71) Applicant: INTERNATIONAL BUSINESS MACHINES CORPORATION, Armonk, NY (US)

(72) Inventors: Christopher J. Butler, South Yarra (AU); Rahil Garnavi, Melbourne (AU); Timothy M. Lynar, Kew (AU)

(73) Assignee: International Business Machines Corporation, Armonk, NY (US)

(21) Appl. No.: 13/888,556

(22) Filed: May 7, 2013

(51) Int. Cl. G06T 7/00

(52) U.S. Cl. CPC G06T 7/0097
USPC 382/108

(57) ABSTRACT

Embodiments relate to assessing a road by acquiring, by a computing device comprising a processor, one or more images of at least a segment of a surface of the road, analyzing, by the computing device, the one or more images to determine a quality associated with the road, predicting, by the computing device, a change in the quality based on the analysis, and generating, by the computing device, a report comprising the predicted change in the quality.

### BACKGROUND

The present invention relates generally to computing technology, and more specifically to an assessment of infrastructure via one or more imaging sources.

In order to provision both corrective and preventative maintenance of transport infrastructure (e.g., flexible and ridged pavements), inspection of the road surface is required. Regular inspection can reduce costs by allowing preventative maintenance to be scheduled well before the road surface reaches a state that requires greater corrective action. Preventative maintenance is significantly lower in cost than corrective maintenance. As such, there is a need to effectively and cheaply survey a transportation network such that appropriate preventative maintenance may be made.

A number of specialized systems exist to measure the quality of a road surface. Such systems are typically vehicle-mounted, and may be based on electro-mechanical, laser range-finding, and optical technologies. The vehicle-mounted nature of the systems requires extensive time, and therefore cost, to gather a holistic perspective of the transportation network.

### BRIEF SUMMARY

An embodiment is directed to a method for assessing a road comprising: acquiring, by a computing device comprising a processor, one or more images of at least a segment of a surface of the road, analyzing, by the computing device, the one or more images to determine a quality associated with the road, predicting, by the computing device, a change in the quality based on the analysis, and generating, by the computing device, a report comprising the predicted change in the quality.

An embodiment is directed to a computer program product comprising: a computer readable storage medium having program code embodied therewith, the program code executable by a processing device to: acquire one or more images of at least a segment of a transportation network, analyze the one or more images to determine a quality associated with the transportation network, predict a change in the quality based on the analysis, and generate a report comprising the predicted change in the quality.

An embodiment is directed to an apparatus comprising: at least one processor, and memory having instructions stored thereon that, when executed by the at least one processor, cause the apparatus to: acquire one or more images of at least a segment of a transportation network, analyze the one or more images to determine a quality associated with the transportation network, predict a change in the quality based on the analysis, and generate a report comprising the predicted change in the quality.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic block diagram illustrating an exemplary computing system in accordance with one or more aspects of this disclosure; and

FIG. 2 illustrates a flow chart of an exemplary method in accordance with one or more embodiments.

### DETAILED DESCRIPTION

Embodiments described herein are directed to methods, apparatuses, and systems for collecting images associated with a transportation network. An assessment may be performed to include a quantified and/or a qualified analysis of the transportation network. In some embodiments, existing imaging datasets are employed as data-sources. The datasets may be collected at regular intervals or at relatively high frequencies. By employing a time series analysis of a captured dataset, a degradation rate in the transportation network (e.g., a roadway) may be predicted and preventative maintenance may be scheduled.

The datasets may include satellite imagery, aerial surveys, and output provided by fixed or moving cameras. The datasets may be captured for purposes other than performing maintenance. For example, the datasets may be at least partially captured based on survey activities or any other activity. In this manner, datasets that have already been captured may be used for other purposes, reducing cost and expense while maximizing the value of the datasets. Such techniques may be used in connection with difficult to reach or inaccessible infrastructure, such as roads located in rural areas. A rural area may comprise an area that has a population density less than a threshold or has infrastructure and/or buildings in an amount or density that is less than a (second) threshold.

In some embodiments, multiple image analysis and computer vision techniques (based on, e.g., color, texture, morphology, time-series, etc.) may be employed to facilitate a comprehensive analysis of a surface of a roadway. Analysis may be targeted to measure rutting, scuffing, soiling, and cracking of the road surface. These measurements may be combined (e.g., weighted relative to one another) as a total road surface damage indicator employed to indicate damage.

In some embodiments, a temporal analysis of images (e.g., a time-series analysis) is employed to estimate a progression of road surface damage over time. The analysis may include application of image processing and pattern matching techniques, such as cross-correlation, on images of the same surface or object over time. In this manner, any changes that occur may be detected.

In some embodiments, preventative and corrective maintenance may be scheduled based on one or more assessments or analyses. The maintenance may be scheduled based on user input or may be scheduled automatically.

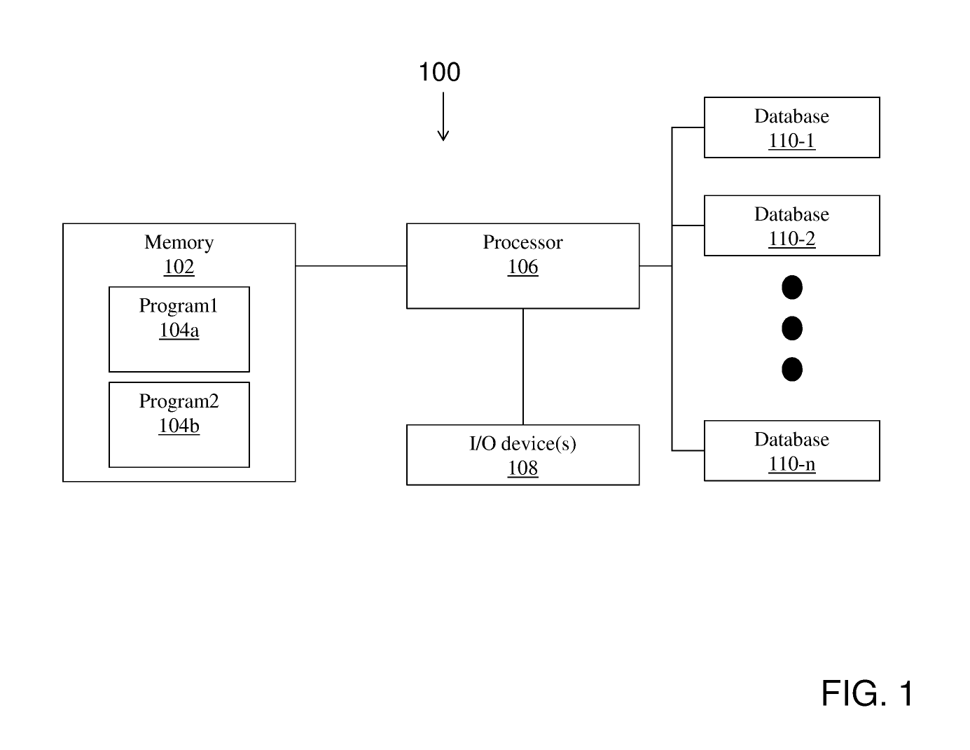

Referring to FIG. 1, an exemplary computing system 100 is shown. The system 100 is shown as including a memory 102. The memory 102 may store executable instructions. The executable instructions may be stored or organized in any manner and at any level of abstraction, such as in connection with one or more processes, routines, procedures, methods, etc. As an example, at least a portion of the instructions are shown in FIG. 1 as being associated with a first program 104a and a second program 104b.

The instructions stored in the memory 102 may be executed by one or more processors, such as a processor 106. The processor 106 may be coupled to one or more input/output (I/O) devices 108. In some embodiments, the I/O device(s) 108 may include one or more of a keyboard or keypad, a touchscreen or touch panel, a display screen, a microphone, a speaker, a mouse, a button, a remote control, a joystick, a printer, a telephone or mobile device (e.g., a smartphone), etc. The I/O device(s) 108 may be configured to provide an interface to allow a user to interact with the system 100.

As shown, the processor 106 may be coupled to a number ‘n’ of databases, 110-1, 110-2, . . . 110-n. The databases 110 may be used to store data, such as images acquired from one or more sources. The processor 106 may be operative on the data stored in the databases 110 to schedule or recommend one or more maintenance activities associated with infrastructure (e.g., a transportation network) as described herein.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1.

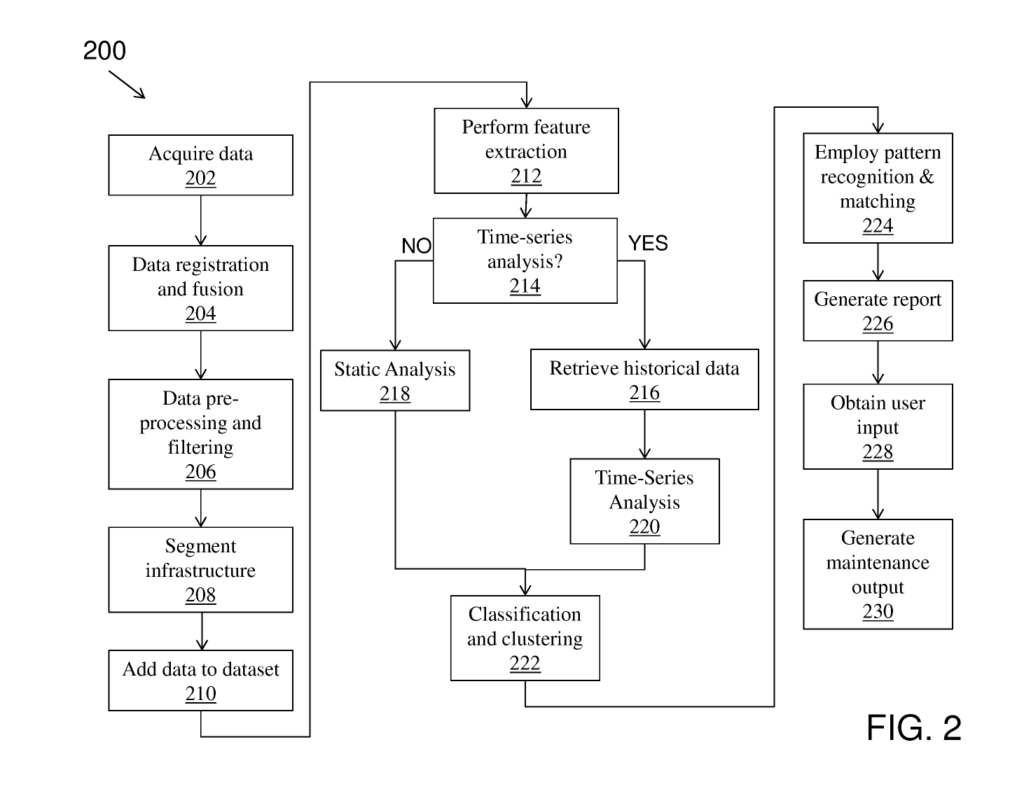

Turning now to FIG. 2, a flow chart of an exemplary method 200 is shown. The method 200 may be executed by one or more systems, components, or devices, such as those described herein. The method 200 may be used to schedule or recommend one or more maintenance activities.

In block 202, one or more data items may be acquired. The data may include images provided from one or more sources. The images may include satellite imagery, aerial surveys, and output provided by fixed cameras. The images may pertain to infrastructure, such as a transportation network (e.g., one or more roadways). Readily available data may be leveraged in order to avoid having to capture data specific to the maintenance activities.

In block 204, the data associated with block 202 may be registered. As part of block 204, the data may undergo a fusion. For example, a set of data obtained from different sources may be combined as part of block 204. As part of block 204, images may be aligned to an underlying feature set. For example, images obtained from one or more sources may be patched together to enhance the features one is interested in, to obtain a wider or more diverse view of an area, or to obtain characteristics of the features from a number of perspectives.

In block 206, the data may be subjected to pre-processing and filtering. For example, extraneous data that is not the subject of an assessment or analysis may be removed or ignored as part of block 206. Geographic information system (GIS) information of, e.g., a road network and of imagery data may be employed to extract relevant regions of the road network. Noise reduction filtering may be performed as part of block 206.

In block 208, segmentation may be performed with respect to the infrastructure. For example, a roadway may be divided into a number of portions or segments. In this manner, a particular level or granularity may be obtained with respect to the infrastructure or an analysis or assessment of the infrastructure.

In block 210, the data may be added to a dataset (e.g., databases 110 of FIG. 1). The dataset may include images of an object or subject (e.g., a segment of infrastructure) taken at various points in time, in order to provide historical perspective of how the object/subject has changed over time.

In block 212, feature extraction may be performed, potentially based on the segmentation of block 208. The feature extraction of block 212 may apply a mathematical formula or algorithm to obtain a feature set or feature vector. The features may be obtained based on one or more levels of abstraction. For example, a low-level set of features associated with a road may include characteristics like color, texture, etc. A high-level set of features for that same road may include characteristics like patterns, a number of potholes or deformations, etc.

In block 214, a determination may be made if a time-series analysis is being used. If so, flow may proceed from block 214 to block 216. Otherwise, flow may proceed from block 214 to block 218.

In block 216, historical data may be retrieved. For example, data may be retrieved based on the dataset associated with block 210.

In block 220, a time-series analysis may be performed on the historical data of block 216.

In block 218, a static analysis may be performed based on the data of block 202.

In block 222, a classification and clustering may be performed with respect to the data. The classification and clustering may be based on the static analysis of block 218 and/or the time-series analysis of block 220. The classification and clustering may map input feature sets or vectors to one or more output classes. The classes may be used to provide systematic organization, particularly where there is a large volume or amount of data that is available.

In block 224, pattern recognition and matching techniques may be employed. The pattern recognition and matching techniques may be employed to facilitate transitioning from data capture and analysis to providing real-world, usable data and recommendations that potentially could be acted on as described below in connection with blocks 226-230.

In block 226, a report may be generated. The report may include one or more recommendations for one or more activities (e.g., preventative and/or corrective maintenance activities) if deemed necessary. In some embodiments, the report may be based on one or more factors or conditions, such as a predicted time until an “unacceptable state” in the infrastructure occurs, the importance of the infrastructure to a system or network (e.g., traffic volumes, frequency of use, road class, etc.), historical decisions about maintenance from problems in the past, etc.

In block 228, user input may be obtained. The user input may be obtained based on the report of block 226. The user input may accept or reject one or more maintenance activities recommended in block 226. The user input may conditionally accept one or more maintenance activities recommended in block 226, potentially subject to one or more changes or modifications. The user input may be based on an evaluation of imagery or an on-site visit. The user input may allow for prioritization of tasks associated with maintenance activities.

In block 230, a maintenance output may be generated. The output may serve to schedule one or more maintenance activities. As part of block 230, one or more resources (e.g., manpower, equipment, etc.) may be allocated to the maintenance activities.

Excluding disruptive phenomenon, such as natural disasters, infrastructure may be subject to gradual degradation. Employing time-series based analytics (e.g., blocks 214, 216, and 220 of FIG. 2) may allow a rate of degradation to be track and a rate of degradation to be predicted. As an example, pothole and rutting are common pavement distress problems, and each may manifest a particular pattern within an image taken from a road segment. The patterns may be detected using image processing techniques.

To detect a pothole, edge-detection based techniques may be applied, which would include: (i) filter the image (e.g., median filter) to remove or ignore noise, (ii) employ edge detection operations (e.g., Canny, Sobel, etc.) to detect the edge of the pothole, (iii) apply convex hull and interpolation to close the curve/shape, and (iv) apply morphological operators to fill the pothole, to eventually be able to get an estimation of the area of the pothole and the extent of any potential damage. Additionally, or alternatively, a threshold-based technique (e.g., an Otsu technique) may be used to separate the pothole region from the surrounding unaffected pavement so long as sufficient contrast in the image is available.

To detect rutting, the above-described edge-detection based techniques may be applied. However, instead of applying the convex hull to detect a circle, line segments may be detected through various techniques, such as a Hough transform.

Embodiments of the disclosure may be used in connection with road marking painting. For example, road surfaces may be marked with various ‘painted’ safety indicators. The quality of these markers may decrease or reduce over time due to, e.g., weather and vehicle use/contact. The degradation in the quality of the markers would also serve to decrease visibility to drivers and to any images taken of the roadway. A threshold may be established which would trigger a maintenance action on the markers. For example, when the visibility of the markers is less than a threshold, maintenance crews may be directed to re-apply paint to the markers.

Embodiments of the disclosure may be used in connection with roads with ‘soft edges’, e.g., roads where there is little to no guttering and therefore there is a transition from artificial road surfaces to earthen shoulders. Damage may erode the artificial surface of the road towards the centerline. Such damage/erosion may become critical when travel lanes are breached. Measuring the width of the artificial surface may allow a prediction of when such breaching might occur, allowing preventative maintenance to be scheduled.

In some embodiments, feedback may be used to enhance accuracy or predictive capabilities. For example, user input (e.g., block 228 of FIG. 2) regarding priorities may be used to enhance or select recommendations to present in one or more (future) reports (e.g., block 226 of FIG. 2). In some embodiments, the feedback may include external maintenance requests. The external maintenance requests may be generated where unacceptable degradation was not automatically identified.

Technical effects and benefits include an identification of one or more maintenance activities with respect to infrastructure. The maintenance activities may include preventative and/or corrective activities, potentially based on a prediction regarding how the infrastructure may change or deteriorate over time. The infrastructure may include one or more portions or segments of a transportation network. While some of the examples described herein pertained to roadways, the transportation network could include any mode of transportation (e.g., flight, marine transport, etc.). Furthermore, the infrastructure could relate to any technology (e.g., computers, plastics, manufacturing) at any level of abstraction.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for assessing a road comprising:
acquiring, by a computing device comprising a processor, one or more images of at least a segment of a surface of the road;
analyzing, by the computing device, the one or more images to determine a quality associated with the road;
predicting, by the computing device, a change in the quality based on the analysis; and
generating, by the computing device, a report comprising the predicted change in the quality.

2. The method of claim 1, further comprising:
segmenting, by the computing device, the road into a plurality of segments; and
analyzing, by the computing device, the one or more images based on the plurality of segments to determine a plurality of qualities associated with the corresponding plurality of segments.

3. The method of claim 1, wherein the one or more images are obtained by the computing device from at least one source, and wherein the at least one source comprises at least one of: aerial photography, satellite image data, a fixed camera, and a moving camera.

4. The method of claim 1, wherein the report comprises a recommendation for a maintenance activity to be performed on the road based on the analysis of the one or more images and the predicted change in the quality.

5. The method of claim 1, where the one or more images comprises at least two images of the segment taken at different points in time, and wherein the analysis of the at least two images comprises determining a change in the quality of the surface of the road over the different points in time.

6. The method of claim 1, further comprising:
performing, by the computing device, filtering on the one or more images prior to the analysis of the one or more images in order to remove an extraneous feature from the one or more images.

7. The method of claim 1, further comprising:
receiving, by the computing device, user input regarding the report, wherein the user input is based on at least one of:
an acceptance of one or more maintenance activities recommended in the report,
a rejection of one or more maintenance activities recommended in the report,
a conditional acceptance of one or more maintenance activities recommended in the report subject to one or more modifications,
a user evaluation of the one or more images,
a user visit to the at least a segment, and
a prioritization of tasks associated with maintenance activities for the road; and
generating, by the computing device a maintenance output based on the report and the user input.

8. The method of claim 1, wherein the quality pertains to at least one of a pothole and rutting with respect to the road.

9. The method of claim 1, wherein the report comprises a predicted time until an unacceptable state in the road occurs, an identification of the importance of the road to a system or network, and a historical decision about maintenance from a problem to the road in the past.

10. A computer program product comprising:
a computer readable storage medium having program code embodied therewith, the program code executable by a processing device to:
acquire one or more images of at least a segment of a transportation network;
analyze the one or more images to determine a quality associated with the transportation network;
predict a change in the quality based on the analysis; and
generate a report comprising the predicted change in the quality.

11. The computer program product of claim 10, wherein the one or more images comprises a plurality of images taken from at least two perspectives, and wherein the program code is executable by the processing device to:
align the plurality of images onto an underlying feature set.

12. The computer program product of claim 10, wherein the one or more images comprises a plurality of images captured at different points in time, and wherein the program code is executable by the processing device to:
determine a change in the quality over the different points in time,
wherein the predicted change in the quality is based on the determined change in the quality over the different points in time.

13. The computer program product of claim 10, wherein the program code is executable by the processing device to:
analyze the one or more images using a static analysis to determine the quality associated with the transportation network.

14. The computer program product of claim 10, wherein the program code is executable by the processing device to:
apply a mathematical algorithm to the one or more images to obtain a feature set; and
classify the one or more images based on the feature set.

15. An apparatus comprising:
at least one processor; and
memory having instructions stored thereon that, when executed by the at least one processor, cause the apparatus to:
acquire one or more images of at least a segment of a transportation network;
analyze the one or more images to determine a quality associated with the transportation network;
predict a change in the quality based on the analysis; and
generate a report comprising the predicted change in the quality.

16. The apparatus of claim 15, wherein the one or more images are captured for a purpose other than use in connection with the transportation network.

17. The apparatus of claim 15, wherein the transportation network comprises a road.

18. The apparatus of claim 17, wherein the instructions, when executed by the at least one processor, cause the apparatus to:
perform a feature extraction on the one or more images to obtain at least one low-level quality associated with the road and at least one high-level quality associated with the road.

19. The apparatus of claim 15, wherein the instructions, when executed by the at least one processor, cause the apparatus to:
provide in the report a recommendation for a preventative maintenance activity to be performed on the transportation network based on the predicted change in the quality.

20. The apparatus of claim 19, wherein the recommendation comprises a suggested time frame for performing the preventative maintenance activity, and wherein the recommendation comprises a prioritized list of a plurality of recommended maintenance activities, and wherein the preventative maintenance activity is included in the list, and wherein the recommendation comprises an identification of at least one resource that is recommended to be used in performing the preventative maintenance activity.
